(19) United States
(12) Patent Application Publication
(10) Pub. No.: US 2025/0387782 A1
(43) Pub. Date: Dec. 25, 2025

(54) CORE-SHELL STRUCTURED CATALYSTS FOR HYDROGEN PRODUCTION FROM NATURAL GAS

(71) Applicant: SAUDI ARABIAN OIL COMPANY, Dhahran (SA)

(72) Inventors: Sehmus Ozden, Houston, TX (US); Ayrat Gizzatov, Winchester, MA (US); Feng Liang, Houston, TX (US); Atieh H. Abu Raqabah, Houston, TX (US)

(73) Assignees: ARAMCO SERVICES COMPANY, Houston, TX (US); SAUDI ARABIAN OIL COMPANY, Dhahran (SA)

(21) Appl. No.: 18/751,701

(22) Filed: Jun. 24, 2024

(51) Int. Cl. B01J 35/30; B01J 13/02; B01J 35/00; B01J 35/50; C01B 3/58

(52) U.S. Cl. CPC B01J 35/397; B01J 13/02; B01J 35/19; B01J 35/395; B01J 35/50; C01B 3/586; C01B 2203/1041

(57) ABSTRACT

A high entropy alloy catalyst and a method of producing hydrogen via catalytic methane pyrolysis are disclosed. The catalyst comprises a core-shell structure, where the core is an internal catalyst support, and the shell comprises a high entropy alloy encapsulating the core. The method includes introducing a high entropy alloy catalyst into a reactor. The method further includes introducing natural gas into the reaction to form a reaction mixture, operating the reactor comprising the reaction mixture, thereby forming hydrogen gas and solid carbon, and separating the hydrogen gas from the solid carbon.

### BACKGROUND

Hydrogen is an emerging clean fuel source with potential to power energy storage, electrical production, vehicle propulsion, and other applications. Hydrogen can be converted to usable energy (including electrical energy) with low or no carbon dioxide emissions using technologies such as fuel cells, as the product of hydrogen used in fuel cells is water, heat, and electricity.

Methane derived from natural gas is the current conventional source for a majority of hydrogen production. Conventional methods of producing hydrogen include steam methane reforming (SMR), autothermal methane reforming (ATR), and partial oxidation of methane (POM). SMR, ATR and POM have a primary disadvantage of high CO₂ emissions that negate the clean-burning advantages of using hydrogen as a fuel source. Additional disadvantages of conventional hydrogen production methods include high energy consumption, high cost, low reaction efficiency, low process stability, and low efficiency of catalyst.

Conventional production of hydrogen (including ATR, SMR, POM, and catalysis of methane without oxygen) may involve use of conventional catalyst technology. Catalyst efficiency is one of the key issues with efficient hydrogen production. Conventional catalysts such as monometallic, bimetallic noble, non-noble metal catalysts, and non-metal catalysts may have limited efficiency and limited lifespan due to the compositions of the catalyst, size effects, surface area effects, porosity, defect density, promotor effects, support effects, coordination state of metal in the catalyst, acid-base properties of the catalyst, or any combination thereof. Catalyst efficacy, among other things, hampers large-scale hydrogen production facilities via said methods.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a high entropy alloy catalyst. The catalyst comprises a core-shell structure, where the core is an internal catalyst support, and the shell comprises a high entropy alloy encapsulating the core.

In another aspect, embodiments disclosed herein relate to a method of producing hydrogen via catalytic methane pyrolysis. The method includes introducing a high entropy alloy catalyst into a reactor. The high entropy catalyst comprises a core-shell structure, where the core is an internal catalyst support, and the shell comprises a high entropy alloy encapsulating the core. The method further includes introducing natural gas into the reaction to form a reaction mixture, operating the reactor comprising the reaction mixture, thereby forming hydrogen gas and solid carbon, and separating the hydrogen gas from the solid carbon.

Other aspects and advantages of the claimed subject matter will be apparent from the following description and the appended claims.

### BRIEF DESCRIPTION OF DRAWINGS

FIG. 1 is an illustration of a high entropy alloy catalyst showing the core-shell structure according to one or more embodiments of the present disclosure.

FIG. 2 is an illustration of a high entropy alloy catalyst showing the core-shell structure including a catalyst promoter in the shell, according to one or more embodiments of the present disclosure.

FIG. 3 is an illustration of a high entropy alloy catalyst showing the core-shell structure including a catalyst promoter in the core, according to one or more embodiments of the present disclosure.

FIG. 4 is an illustration of a high entropy alloy catalyst showing the core-shell structure including a catalyst promoter in the core and the shell, according to one or more embodiments of the present disclosure.

FIG. 5 illustrates a diagram of a method for producing hydrogen and solid carbon according to one or more embodiments of the present disclosure.

FIG. 6 illustrates a diagram of a method for producing hydrogen according to one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to catalysts for the production of hydrogen and, more particularly, to catalysts for the production of hydrogen from natural gas (e.g., methane).

The present disclosure provides methods and systems for hydrogen production from natural gas (e.g., methane) utilizing a catalyst that includes a high entropy alloy. The high entropy alloy catalyst may allow for high catalyst stability and high conversion of natural gas (e.g., methane) to hydrogen gas with high specificity.

### High Entropy Alloy Catalyst

“Catalyst,” “catalytic,” “catalysis,” and grammatical variants thereof, as used herein, refers to a chemical compound (or process of using such a chemical compound) that increases the rate of a chemical reaction without being consumed during the reaction. A catalyst may comprise additional components such as, for example, a secondary phase, a catalyst support, a catalyst promotor, the like, or any combination thereof.

“High entropy alloy catalyst” as used herein refers to a catalyst that comprises a core-shell structure wherein the core is an internal catalyst support and the shell comprises a high entropy alloy encapsulating the core. A high entropy alloy catalyst may comprise additional components as described for a catalyst above.

“High entropy alloy” as used herein, refers to a catalytic composition that has a mixed configuration entropy, S, of S≥11J K⁻¹ mol⁻¹. The catalytic composition comprises a metal alloy whose composition consists of at least four metal elements, with each element having a concentration of from 0.1 atomic percent (at %) to 50 at %.

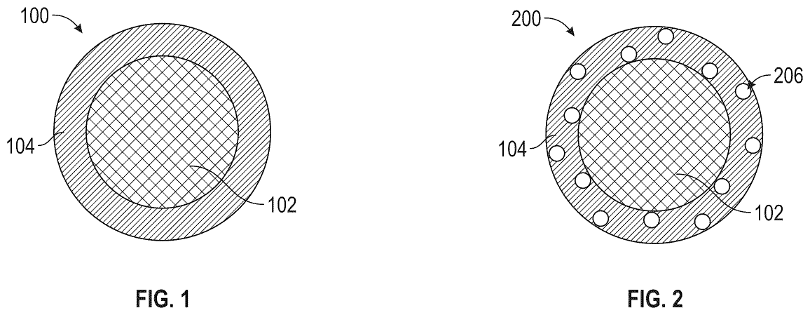

As noted above the high entropy catalyst has a core-shell structure. The shell includes a high entropy alloy. FIG. 1 illustrates a nonlimiting core-shell structure of the present disclosure. The core-shell structure 100 comprises a core 102 surrounded by a high entropy alloy shell 104. Mixed configuration entropy, S, of a composition (e.g., an alloy) that includes more than one elemental species is typically calculated according to Equation 1 below.

$$S = - R \sum {x}_{i} ln ( {x}_{i} ) \qquad Equation 1$$

where R is the molar gas constant (equal to about 8.314 J K⁻¹ mol⁻¹), and xᵢ is a mole fraction of an individual elemental species (e.g., an individual metal). Equation 1 may be simplified for alloys with an equimolar ratio of elements to Equation 2 below.

$$S = R ln n \qquad Equation 2$$

where n is the number of individual elemental species present in the alloy.

An alloy may be considered a high entropy alloy if the entropy, S, is greater than the entropy of mixed configuration of an equimolar compound with 4 species, or preferably 5 species. If the number of equimolar elemental species present is 4 then S=1.36R. In a more preferred case, the number of equimolar elemental species present may be 5, and thus S=1.5R. Thus, if the alloy has an entropy S, such that S≥1.36R, it satisfies the expression of S≥11J K⁻¹ mol⁻¹ and the alloy is considered a high entropy alloy.

The high entropy alloys that are suitable for use in the core-shell catalysts for hydrogen production in accordance with the present disclosure may comprise precious and transition metals including, but not limited to, cobalt, chromium, iron, manganese, nickel, aluminum, magnesium, copper, zinc, zirconium, ruthenium, rhodium, palladium, silver, molybdenum, niobium, tungsten, rhenium, iridium, platinum, gold, cerium, ytterbium, tin, calcium, beryllium, the like, or any combination thereof. The various precious and transition metals can individually present different catalytic efficiencies for methane pyrolysis depending on their core. The same can be said for different combinations of metals and the core being used. It should be noted that the high entropy alloy may comprise at least 4 and up to 30 suitable metals in any combination. In some embodiments, the high entropy alloy comprises at least 5 suitable metals. In some embodiments, the number of suitable metals in the high entropy alloy has a lower limit of any of one 4, 5, 6, 7, 9, 10, 12, 15, and 20 metals and an upper limit of any one of 6, 7, 8, 9, 10, 15, 20, 25 and 30 metals, where any lower limit may be paired with any upper limit. Each metal in the high entropy alloy may be included in the composition in an amount ranging from 0.1 at % to 50 at % of the high entropy alloy. In some embodiments, each metal in the high entropy alloy may be included in the composition in an amount ranging from a lower limit of any one of 0.1, 1.0, 1.5, 2.0, 5.0, 7.0, 10.0, and 12.0 at % and an upper limit of any one of 10.0, 12.0, 15.0, 17.0 and 20.0 at %, where any lower limit may be paired with any mathematically compatible upper limit.

The high entropy alloy may exhibit an enhanced catalytic performance from the usage of multiple elements. In some embodiments, each metal may contribute its unique properties, including, but not limited to, electronic structure, lattice distortion, and diffusion behavior. In some embodiments, the alloying of multiple elements may produce complex interactions impacting such nonlimited factors as lattice distortion, atomic arrangement, and electronic interactions that determine overall catalytic behavior. It should be noted that, in many such embodiments, the alloying of multiple elements yields enhanced synergistic interactions.

The high entropy alloy shell may have an average thickness from 1 nanometer (nm) to 10 micrometers (μm). In some embodiments, the high entropy alloy shell has an average thickness with a lower limit of any one of 1 nm, 5 nm, 10 nm, 50 nm, 100 nm, 500 nm and 1 μm and an upper limit of any one of 1 μm, 5 μm and 10 μm, where any lower limit may be paired with any mathematically compatible upper limit. The high entropy alloy shell may encapsulate any shape including, but not limited to, spherical, cubic, triangular, oblong, irregular, or any combination thereof.

The high entropy alloys may have a metal crystalline structure including, but not limited to, a face centered cubic (FCC), a body centered cubic (BCC), a hexagonal close packed (HCP) structure, the like, or any combination thereof. Furthermore, high entropy alloys of the present disclosure may have an amorphous structure or may have a structure comprising a combination of crystalline metal and amorphous components.

The high entropy alloy in the catalyst may provide additional features to the catalyst including increased activity and decreased adsorption energy. Without being bound by theory, it is believed that the presence of additional elements contributing to the high entropy of the high entropy catalyst allows for additional atomic arrangements on the surface of the catalyst, which effects the number and distribution of catalytic active sites, as well as the adsorption and desorption of hydrogen and reactants. HEAs as a shell structure may possess high catalytic active sites, high surface area, high stability and durability and resistance to coking.

As noted above, the high entropy alloy catalyst comprises a core-shell structure wherein the core is an internal catalyst support and the shell comprises a high entropy alloy encapsulating the core.

The “core” and grammatical variants thereof, as used herein, refers to a compound or material to which the catalyst is affixed for providing additional features. The core used in the present disclosure may comprise any suitable catalyst support material including, but not limited to, a metal, a metal oxide, a zeolite, carbon black, a secondary phase, the like, or any combination thereof. Suitable metal oxides may include, but are not limited to, Al₂O₃, Al₂O₄, SiO₂, MgO, TiO₂, Fe₂O₄, FeO, ZrO₂, CeO₂, a lanthanide oxide (e.g., Er₂O₃), the like, or any combination thereof. As noted above, the various precious and transition metals combinations, or individually, can present different catalytic efficiencies for methane pyrolysis depending on their core. In choosing an appropriate core, high surface area, high chemical and thermal stability, and interface interactions between the various metals and core are evaluated for their catalytic efficiency. The high entropy alloy catalyst may comprise from 0.0001 at % to 50 at % of the core. In some embodiments, the amount of the core in the high entropy alloy catalyst has a lower limit of any one of 0.0001, 0.001, 0.01, 0.1 1.0, 2.5, 5.0, 10.0 and 15.0 at % and an upper limit of any one of 1.0, 2.5, 5.0, 10.0, 15.0, 20.0, 30.0 and 40.0 at %, where any lower limit may be paired with any mathematically compatible upper limit. An “internal catalyst support” as used herein refers to the catalyst support being embedded in the high entropy alloy structure. As nonlimiting examples, FIGS. 1-4 illustrate a core-shell high entropy alloy catalyst with an internal catalyst support (core, 102) and a high entropy alloy (shell, 104); the embodiments of FIGS. 2-4 further includes a promoter 206.

The core may have an average size from 1 nanometer (nm) to 10 micrometers (μm). In some embodiments, the core has an average size with a lower limit of any one of 1 nm, 10 nm, 25 nm, 50 nm, 100 nm, 500 nm, and an upper limit of any one of 1 μm, 3 μm, 5 μm, 7 μm and 10 μm, where any lower limit may be paired with any mathematically compatible upper limit. The core may be of any shape including, but not limited to, spherical, cubic, triangular, oblong, irregular, or any combination thereof. Thus, the average size of the core may be defined as the average width, length, height, diameter, or any combination thereof.

The core, in conjunction with the high entropy alloy catalyst, may serve to increase the efficiency of the catalysis. The core may provide features to the high entropy alloy catalyst such as, for example, increasing alloy dispersion, improving sintering resistance, increasing the rate of reactant adsorption, or any combination thereof. The core may additionally prevent coke formation on the surface of the high entropy alloy catalyst, maintaining increased catalyst activity for a longer time duration. The core may function by interacting chemically, physically, or chemically and physically, with the other components of the high entropy alloy catalyst, a reaction substrate, or any combination thereof.

The core structure as a catalyst support may serve as a physical framework that holds the catalyst within the reacting system, and it should have good thermal and mechanical stability and may have some catalytic activity of its own. The core structure as a support behaves as a base for the active materials in the highly energized reaction system and helps in the active metal dispersion.

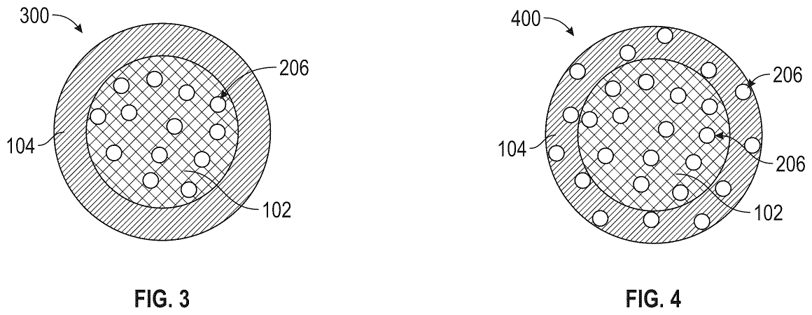

A catalyst promotor may be included in the high entropy alloy catalyst. “Catalyst promotor” and grammatical variants thereof, as used herein, refer to a compound provided with a catalyst for increasing the catalytic activity of the catalyst. The catalyst promotor used in the present disclosure may comprise any suitable catalyst promotor material including, but not limited to, a metal, a metal oxide, a secondary phase, and the like, or any combination thereof. Suitable catalyst promotor materials may include, but are not limited to, an alkali metal (e.g., lithium, sodium, potassium, cesium, francium, or any combination thereof), an alkali earth metal (e.g., calcium, magnesium, barium, or any combination thereof), a rare earth metal (e.g., scandium, titanium, vanadium, chromium), a transition metal (e.g., iron, cobalt, manganese, magnesium, nickel, molybdenum, copper, palladium, platinum, rhenium, or any combination thereof), a post-transition metal (e.g. aluminum, gallium), a cerium compound (e.g., cerium, a cerium oxide (e.g., Ce₂O₃, CeO₂, or any combination thereof), or any combination thereof), a lanthanide (e.g., lanthanum, neodymium, or any combination thereof), a metal oxide (e.g., MgO, Ca₂SiO₄, CaO, or any combination thereof), a germanium compound, the like, or any combination thereof. The catalyst promotor may comprise from 0.0001 at % to 20 at % of the catalyst. In some embodiments, the catalyst promoter comprises a lower limit of any one of 0.0001, 0.001, 0.01, 0.1 1.0, 2.5, 5.0, 10.0 and 15.0 at % and an upper limit of any one of 1.0, 2.5, 5.0, 10.0, 15.0, and 20.0 at % of the catalyst, where any lower limit may be paired with any mathematically compatible upper limit. The catalyst promotor may be embedded in the core, in the shell, or any combination thereof. FIG. 2 illustrates a nonlimiting core-shell structure of the present disclosure. The core-shell structure 200 comprises a core 102 surrounded by a high entropy alloy shell 104 with catalyst promoter 206 within the shell 104. FIG. 3 illustrates another nonlimiting core-shell structure of the present disclosure. The core-shell structure 300 comprises a core 102 surrounded by a high entropy alloy shell 104 with catalyst promoter 206 within the core 102. FIG. 4 illustrates yet another nonlimiting core-shell structure of the present disclosure. The core-shell structure 400 comprises a core 102 surrounded by a high entropy alloy shell 104 with catalyst promoter 206 within the shell 104 and the core 102.

The catalyst promotor used in the present disclosure may serve as a chemical promotor, a structural promotor, or any combination thereof. When serving as a chemical promotor, the catalyst promotor may improve the efficiency of the catalyst by, without being bound by theory, altering the distribution of electrons at the surface of the catalyst. When serving as a structural promotor, the catalyst promotor may alter mechanical properties of the catalyst such as, for example, increase sintering resistance. The catalyst promotor may also provide additional features such as increasing selectivity of the catalyst for a particular reactant. Without being bound by theory, the catalyst promotor may increase adsorption and chemisorption for a specific reactant at an active site of the catalyst, thus increasing selectivity. The catalyst promotor may also increase the durability of the catalyst.

It should be noted that in some embodiments the catalyst promotor may be a metal that in other embodiments may be the core, and yet in other embodiments may comprise the high entropy alloy shell. In other words, a single metal may provide catalytic activity in some embodiments, may serve as a catalyst promotor in other embodiments, and may serve as an internal catalyst support in yet other embodiments. Without being bound by theory, the function of a metal may be determined by other components in the high entropy alloy catalyst and interactions with the other elements and compounds. By way of an illustrative nonlimiting example, in a first case a high entropy alloy catalyst may comprise a high entropy alloy shell wherein the high entropy alloy comprises nickel, aluminum, zirconium, palladium, and zinc, and wherein the high entropy alloy catalyst further comprises copper as a core. In the aforementioned nonlimiting example, copper oxide (CuO) may, depending on the embodiment, comprise the high entropy alloy, may serve as a catalyst promotor, or may serve as the core. It should be further noted that copper in other oxidation states may be used in the alloy, promoter, or core as previously described. These derivatives may exhibit different chemistries that may be useful for purposes nonlimited herein. However, those skilled in the art will appreciate that Cu(II) may exhibit better catalytic properties when used in embodiments of the present disclosure, including but not limited to higher active sites for adsorption and reaction intermediates due to its stability, redox properties, and active surface sites.

The catalyst promoters may generally increase the catalyst's ability to facilitate the reactions, particularly methane dissociation, enhance the HEA catalyst's resistance to deactivation and minimize coke formation. The catalyst promoter may also prevent particle coalescence and/or sintering, maintain the catalyst's active surface area over time and withstand at high temperatures.

The high entropy alloy catalysts described herein may also further comprise a secondary phase. The secondary phase may interact with any component of the high entropy alloy catalyst and may provide features such as increased catalytic activity to the catalyst. As noted above, the secondary phase or portions thereof may serve as a catalyst promotor, an internal catalyst support, or any combination thereof. The secondary phase may comprise any suitable composition including, but not limited to, an intermetallic phase, a laves phase, a carbide phase, a boride phase, a borocarbide phase, a nitride phase, a silicide phase, an aluminide phase, an oxide phase (e.g. MgO, Al₂O₃, or any combination thereof), a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

The high entropy alloy catalyst may be present in the form of a plurality of particles. The plurality of particles may have an average size from 1 nanometer (nm) to 10 micrometers (μm). In some embodiments, the plurality of particles has an average dimension with a lower limit of any one of 1 nm, 5 nm, 10 nm, 50 nm, 100 nm, 500 nm and 1 μm and an upper limit of any one of 1 μm, 3 μm, 5 μm, 7 μm and 10 μm, where any lower limit may be paired with any mathematically compatible upper limit. The average size of the plurality of particles may be defined as the average width, length, height, diameter, or any combination thereof of a particle. The particles may be of any shape including, but not limited to, spherical, cubic, triangular, oblong, irregular, or any combination thereof. The plurality of particles may be formed to a catalyst bead, catalyst pellet, or any combination thereof in any suitable shape and size.

Promoter metals may improve the selectivity, durability, and activity of catalysts, thus limiting the coke formation, active oxidation, sintering, and segregation. The desirable physical properties of high entropy alloy catalysts are high surface area, porosity, good thermal stability, corrosion resistance.

The high entropy alloy catalyst may further comprise a non-stick additive. The non-stick additive may prevent sticking of solid carbon to the high entropy alloy catalyst, potentially maintaining the activity of the high entropy alloy catalyst for an extended period of time, reducing the need to clean or replace the high entropy alloy catalyst, thus reducing costs. The nonstick additive may comprise any suitable material including, but not limited to, a magnesium silicate, a borosilicate, a borate, aluminum oxide, silicon dioxide, titanium oxide, zirconium oxide, the like, or any combination thereof.

### Method of Making the High Entropy Alloy Catalyst

The high entropy alloy shell may be manufactured using synthesis in solid phase, liquid phase, gas phase, or any combination thereof. The synthesis method used may comprise any suitable method of manufacturing a high entropy alloy including, but not limited to, dealloying of bulk high entropy alloys, wet-chemical methods such as solvothermal, ultrasonication, and sol-gel auto-combustion, spray pyrolysis, carbothermal shock synthesis, a hydrothermal method, pulse-laser ablation, mechanical milling, arc melting, induction melting, a metal spray technique, molecular beam epitaxy, atomic layer deposition, chemical vapor deposition, pulsed laser deposition, the like, or any combination thereof.

The core may be synthesized using any suitable method of manufacturing an internal catalyst support including, but not limited to, using a reduction of metal salts such as sodium borohydride (NaBH₄) or hydrazine (N₂H₄) in a microemulsion or aqueous phase, redox-transmetalation method, thermal decomposition of organometallic compounds, sonochemical synthesis, sol-gel methods, or any combination thereof.

The core-shell structure of the high entropy alloy catalyst may be fabricated using a two-step or multiple step process, where at the first step, the core structure is synthesized, and the shell structures are covered on the core element using the second or more steps. The synthesis method used may comprise any suitable method of manufacturing core-shell structures including, but not limited to condensation from vapor, chemical reaction, milling, precipitation, polymerization, microemulsion, sol-gel condensation, and layer by layer adsorption.

For instance, depending on the desired amount, a HEA with a SiO₂ core structure may be produced by the Stoeber process. To synthesize SiO₂ nanoparticles (SiNP), 1 mL-1 L of Igepal CO-520 may be stirred with cyclohexane and 3 mL-100 mL of 30% ammonia mixed with 50-500 mL of dry ethanol. Tetraethyl orthosilicate (TEOS), a silicon based reactant for synthesis of SiNP, may be added to the solution and stirred overnight. The produced SiNP may then be collected by centrifuge and washed with ethanol and water. To create HEA shell structure, a 1% concentration of HEAs solution may be prepared using Iron (III) chloride (FeCl₃), Nickel (III) chloride (NiCl₃), Cobalt (III) chloride (CoCl₃), Copper (II) chloride dihydrate (CuCl₂·2H₂O), Molybdenum (III) chloride (MoCl₃). The pH of HEAs solution may be brought to within the range of 6-10 using NaOH. 15 μl of 1% HEAs solution may be mixed with 500 μl of washed SiNP for 30 min. Then 60 μl of 20 mM NaBH₄ may be added to the mixture of HEAs solution and SiNP to reduce the HEAs solution that will form a shell on the SiNP core structure.

The high entropy alloy catalyst may be analyzed for the measurement of size, shell thickness, elemental and surface properties, optical properties, and thermal stability using characterization techniques such as dynamic light scattering (DLS), scanning electron microscopy (SEM), transmission electron microscopy (TEM), thermal gravimetric analysis (TGA), X-ray photoelectron spectroscopy (XPS), photoluminescence (PL), UV-vis spectroscopy, atomic force microscopy (AFM), energy-dispersive X-ray spectrometry (EDX), BET-surface area, chemisorption, chemisorption and physisorption, Inductively Coupled Plasma Mass Spectrometry (ICP-MS), X-ray absorption coefficient, and Fourier-transform infrared spectroscopy (FTIR).

### Hydrogen Production Methods

The present disclosure furthermore includes methods and systems of hydrogen production utilizing the high entropy alloy catalysts described above.

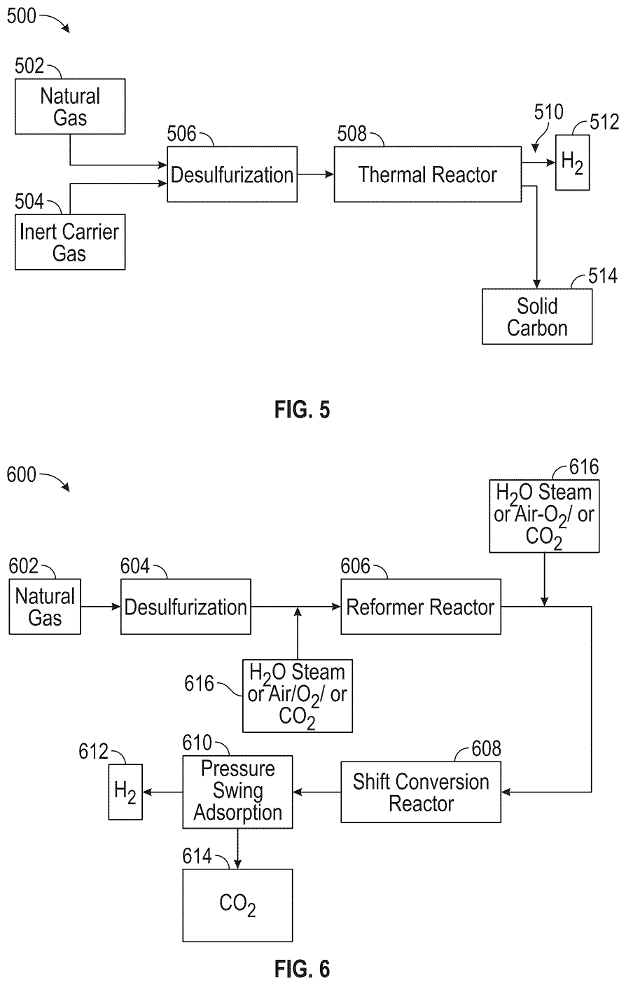

A diagram illustrating a nonlimiting system of the present disclosure is illustrated in FIG. 5. In the system 500, the natural gas 502 and an inert carrier gas (e.g. N₂, argon) 504 are introduced to a desulfurization chamber 506 and then to a thermal reactor 508, wherein the reactor 508 contains therein the high entropy alloy catalyst. The natural gas 502 reacts with the high entropy alloy catalyst to form hydrogen gas and solid carbon. The system 500 may further comprise a separation system 510 for separating the hydrogen gas from the solid carbon to produce a hydrogen stream 512 comprising the hydrogen gas from the reactor and produce solid carbon 514.

The conditions of desulfurization depend on the method and the type of sulfur compound. For catalytic hydrodesulfurization, the natural gas is mixed with hydrogen and passed over a catalyst. The most commonly used catalysts for desulfurization are cobalt molybdate and nickel molybdate catalyst. The desulfurization is usually performed between 400° C.-950° C. at the pressure of 15-40 atm.

The reactor may be a reactor such as, for example, a natural gas pyrolysis reactor. The reactor may be any suitable configuration of reactor including, but not limited to, a packed bed reactor, a fluidized bed reactor, a membrane reactor, the like, or any combination thereof. The reactor may have one or more catalyst beds contained therein, the one or more catalyst beds comprising the high entropy alloy catalyst. The pressure of the reactor may be from 1 bar to 25 bar. In some embodiments, the pressure of the reactor ranges from 1 bar to 20 bar, from 1 bar to 10 bar, from 5 bar to 15 bar, from 10 bar to 20 bar, from 15 bar to 25 bar, or from 0.1 bar to 25 bar. The temperature of the reactor may be from 300° C. to 1200° C. In some embodiments, the temperature of the reactor ranges from 300° C. to 600° C., from 300° C. to 900° C., from 900° C. to 1200° C., or from 100° C. to 1400° C.

It should be noted that “natural gas” as used within the present disclosure refers to any suitable hydrocarbon gas that may include, but is not limited to, methane, the like, or any combination thereof. The natural gas may enter the reactor at any suitable pressure, temperature, and flowrate compatible with the reaction conditions of the reactor. The natural gas may further comprise an inert carrier gas (e.g., nitrogen gas, argon, the like, or any combination thereof). While in the reactor, the natural gas may be catalyzed by the high entropy alloy catalyst to form the hydrogen gas and solid carbon. It should be noted that other impurities may be formed in the reactor in addition to the hydrogen gas and solid carbon and may be intermixed with the hydrogen gas, the solid carbon, or both. The solid carbon may be of any form including, but not limited to, amorphous carbon, carbon nanotubes, nanofibers, graphite, graphene, the like, or any combination thereof.

Separating the hydrogen gas from the solid carbon to produce a hydrogen stream may comprise passing the hydrogen gas through a separation system that may comprise, for example, a separation membrane. The separation membrane may separate the hydrogen gas from the solid carbon, impurities (e.g., unreacted natural gas, the like, or any combination thereof), side products formed during pyrolysis (e.g., ethane, ethene, benzene, hydrogen sulfide, carbon dioxide, the like, or any combination thereof), the like, or any combination thereof. Any suitable separation membrane may be used. The separation system including the separation system may be housed within the reactor or may be external to the reactor.

The system may have a conversion efficiency of from 20% to 99.9%. In some embodiments, the system as a conversion efficiency of from 20% to 60%, from 60% to 99.9%, or greater than 99.9%. Conversion efficiency, CE, may be calculated by Equation 3 below.

$$C E = ( {R}_{FEED} - {R}_{OUTLET} ) / {R}_{FEED} * 100 \qquad Equation 3$$

where R_{FEED} is the quantity of reactant in the feed, and R_{OUTLET} is the quantity of reactant in the outlet.

The hydrogen stream may be of any suitable purity including from 90 mol % to 99.99 mol % percent purity. In some embodiments, the purity of the hydrogen stream ranges from 60 mol % to 99.99 mol %, from 80 mol % to 99.99 mol %, or from 95 mol % to 99.99 mol %. The hydrogen stream may be provided at any suitable temperature and pressure. The pressure and temperature of the hydrogen stream may be affected by the pressure and temperature of the reactor, the separation system, or any combination thereof. The hydrogen stream may subsequently be directed from the separation system to any suitable location including, but not limited to, a pipeline, a storage tank, a railcar tank, the like, or any combination thereof.

The system may have no detectable carbon dioxide emissions. In some embodiments, the system, when used to produce hydrogen via catalytic methane pyrolysis, may generate zero detectable carbon dioxide.

### Hydrogen Production Through Methane Reformation

Another nonlimiting system of the present disclosure for producing hydrogen is illustrated in a diagram in FIG. 6. In the system 600, natural gas 602 is introduced to a desulfurization chamber 604 and then to a reformer reactor 606 containing therein a high entropy alloy catalyst and the natural gas 602 is reacted with the high entropy alloy catalyst in the reformer reactor 606 to form syngas comprising hydrogen gas and carbon monoxide. The syngas may be supplemented with steam, an air stream, or carbon dioxide 616 and introduced to a shift conversion reactor 608 containing therein a high entropy alloy catalyst, and the syngas is reacted with the high entropy alloy catalyst in the shift conversion reactor 608 to convert the carbon monoxide to carbon dioxide. The hydrogen gas and the carbon dioxide are introduced to a pressure swing adsorption unit 610, and the hydrogen gas and carbon dioxide are separated in the pressure swing adsorption unit 610 to produce a hydrogen stream 612 comprising the hydrogen gas and to produce carbon dioxide 614.

As similarly described for FIG. 5, the conditions of desulfurization depend on the method and the type of sulfur compound. For catalytic hydrodesulfurization, the natural gas is mixed with hydrogen and passed over a catalyst. The most commonly used catalysts for desulfurization are cobalt molybdate and nickel molybdate catalyst. The desulfurization is usually performed between 400° C.-950° C. at the pressure of 15-40 atm.

The reformer reactor may be any suitable natural gas reformer reactor such as, for example, a steam methane reforming reactor, an autothermal methane reforming reactor, a partial oxidation of methane reactor, the like, or any combination thereof. The reformer reactor may be any suitable configuration of reactor including, but not limited to, a packed bed reactor, a fluidized bed reactor, a membrane reactor, the like, or any combination thereof. The reformer reactor may have one or more catalyst beds contained therein, the one or more catalyst beds comprising the catalyst. The pressure of the reformer reactor may be from 3 bar to 25 bar. In some embodiments, the pressure of the reformer reactor ranges from 1 bar to 20 bar, from 1 bar to 10 bar, from 5 bar to 15 bar, from 10 bar to 20 bar, from 15 bar to 25 bar, from 0.1 bar to 25 bar, or from 1 bar to 25 bar. The temperature of the reactor may be from 300° C. to 1000° C. In some embodiments, the temperature of the reactor ranges from 300° C. to 1200° C., from 300° C. to 600° C., from 300° C. to 900° C., from 900° C. to 1200° C., or from 100° C. to 1400° C.

The natural gas may enter the reformer reactor at any suitable pressure, temperature, and flowrate compatible with the reaction conditions of the reformer reactor. The natural gas may comprise a carrier gas (e.g., steam, air, carbon dioxide, oxygen gas, nitrogen gas, argon, the like, or any combination thereof). While in the reformer reactor, the natural gas may be catalyzed by the high entropy alloy catalyst to form syngas comprising hydrogen gas and carbon monoxide. The syngas may comprise hydrogen gas and carbon monoxide in any amount, and the syngas may comprise additional species (e.g., carbon dioxide) in any amount.

The shift conversion reactor may comprise a water gas shift reactor or any suitable shift conversion reactor. The syngas may enter the shift conversion reactor at any suitable pressure, temperature, and flowrate compatible with the reaction conditions of the shift conversion reactor. The shift conversion reactor may preferably comprise a water gas shift reactor and may have connected thereto a supply of water for purposes of reaction. The shift conversion reactor may have fluidly connected to it a supply of a carrier gas (e.g., steam, air, carbon dioxide, oxygen gas, nitrogen gas, argon, the like, or any combination thereof). It should be noted that the shift conversion reactor may comprise two reactors or more reactors in series, and the reactors may operate at any suitable temperature and pressure. For example, any of the reactors within the shift conversion reactor may operate at a pressure of from 5 bar to 70 bar and a temperature of from 100° C. to 600° C. In some embodiments, the shift conversion reactors operates at a pressure ranging from 10 bar to 60 bar, or from 10 bar to 40 bar. In some embodiments, the shift conversion reactors operates at a temperature ranging from 100° C. to 500° C., from 150° C. to 300° C., from 150° C. to 250° C., from 190° C. to 150° C., from 250° C. to 500° C., from 300° C. to 500° C., or from 300° C. to 450° C. The shift conversion reactor converts the syngas (and, if present, water) in the presence of a catalyst to hydrogen gas and carbon dioxide. Any suitable catalyst may be used in the shift conversion reactor including a high entropy alloy catalyst described herein, a shift conversion catalyst, or any combination thereof. Examples of suitable shift conversion catalysts may include, but are not limited to, CuO/CeO₂, Fe—Cr/Al₂O₃, Cu/ZnO/Al₂O₃, the like, or any combination thereof. The catalyst used in the shift conversion reactor may be housed within the shift conversion reactor in a reactor bed or similar apparatus.

The pressure swing adsorption unit may comprise any suitable unit including, but not limited to, a pressurized reaction vessel. The pressure swing adsorption unit may use multiple stages for adsorption. The hydrogen gas and carbon dioxide may enter the pressure swing adsorption unit at any suitable pressure, temperature, and flowrate compatible with the pressure swing adsorption unit. The pressure swing adsorption unit may use an adsorptive material. Examples of suitable adsorptive materials may include, but are not limited to, a zeolite (e.g., zeolite 5A, zeolite 13X, the like, or any combination thereof), activated carbon, monoethanolamine (MEA), an MOF (e.g., MOF-5), MgO/C, the like, or any combination thereof. The adsorptive material may be housed in a reaction bed such as, for example, a packed bed, a fluidized bed, the like, or any combination thereof. The pressure swing adsorption unit may vary pressure from an adsorption pressure to a regeneration pressure in order to separate carbon dioxide and hydrogen gas. Suitable adsorption pressures may, for example, be from 1 bar to 10 bar, and suitable regeneration pressures may be from 0.01 bar to 0.1 bar. The pressure swing adsorption unit may produce the hydrogen stream.

The hydrogen stream may be of any suitable purity including from 90 mol % to 99.99 mol % percent purity. In some embodiments, the purity of the hydrogen stream ranges from 60 mol % to 99.99 mol %, from 80 mol % to 99.99 mol %, or from 95 mol % to 99.99 mol %. The hydrogen stream may be provided at any suitable temperature and pressure. The pressure and temperature of the hydrogen stream may be affected by the pressure and temperature of the reformer reactor, the shift conversion reactor, the pressure swing adsorption unit, or any combination thereof. The hydrogen stream may subsequently be directed from the pressure swing adsorption unit to any suitable location including, but not limited to, a pipeline, a storage tank, a railcar tank, the like, or any combination thereof.

Any of the reactors described in any system above may contain a heating system to heat the reactor. The heating system of the reactor may require extensive thermal duty, and thus use of a heating method with lower carbon dioxide emissions may be preferred, though any suitable heating method may be used. Suitable heating methods for use in the present disclosure may include, but are not limited to, hydrocarbon heating, induction heating, plasma heating (e.g., microwave plasma), microwave heating, solar furnace heating, the like, or any combination thereof.

Hydrocarbon heating may comprise burning a hydrocarbon such as, for example, natural gas, gasoline, or any combination thereof in order to provide thermal energy. It should be noted that any suitable heat conduction material, heat transfer fluid, or any combination thereof, may be used to convey heat energy from the burning of the hydrocarbon to the reactor.

The heating system may comprise induction heating. In an induction heating system an electrical current may flow through metal coils to heat metal within the catalyst through electromagnetic induction. Induction heating may increase efficiency of heating by reducing waste heat loss, thus improving the energy efficiency of the reactor.

Plasma heating may comprise a system wherein heat is provided through heating of gasses within the reactor to produce plasma. Microwave heating may comprise a system wherein metal coils are used to produce microwave radiation, heating species within the reactor. Solar furnace heating may comprise a system that utilizes thermal energy from solar radiation and conveys the solar radiation thermal energy to the reactor in order to heat the reactor.

It should be appreciated that one skilled in the art should be able to, with the benefit of this disclosure, implement the methods and systems described above. It should be noted that additional nonlimiting components may be utilized in the methods and systems described above to produce hydrogen. Such additional components will be familiar to one having ordinary skill in the art and may include, but are not limited to, valves, pumps, joints, sensors, compressors, controllers, heat exchangers, the like, or any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A high entropy alloy catalyst, comprising:
a core-shell structure, wherein:
the core is an internal catalyst support, and
the shell comprises a high entropy alloy encapsulating the core.

2. The high entropy alloy catalyst of claim 1, further comprising a catalyst promoter in the core, in the shell, or both; and wherein the catalyst promoter comprises from 0.0001 at % to 20 at % of the high entropy alloy catalyst.

3. The high entropy alloy catalyst of claim 2, wherein the catalyst promoter comprises a metal, an alkali metal, a rare earth metal, a metal oxide, or any combination thereof.

4. The high entropy alloy catalyst of claim 1, wherein the core comprises a metal, a metal oxide, or any combination thereof.

5. The high entropy alloy catalyst of claim 1, wherein the shell comprises at least four metals, and wherein each of the at least four metals is present in the shell in an amount ranging from 0.1 at % to 50 at %.

6. The high entropy alloy catalyst of claim 5, wherein the at least four metals are selected from the group consisting of cobalt, chromium, iron, manganese, nickel, aluminum, magnesium, copper, zinc, zirconium, molybdenum, niobium, ruthenium, rhodium, palladium, silver, tungsten, rhenium, iridium, platinum, gold, cerium, ytterbium, tin, calcium, and beryllium.

7. The high entropy alloy catalyst of claim 1, wherein the core has an average size of from 1 nanometers to 10 micrometers, and wherein the shell has an average thickness of from 1 nm to 10 μm.

8. The high entropy alloy catalyst of claim 1, wherein the high entropy alloy catalyst is spherical, square, cubic, triangular, or an irregular shape.

9. A method of producing hydrogen via catalytic methane pyrolysis, the method comprising:
introducing a high entropy alloy catalyst into a reactor, the high entropy catalyst comprising:
a core-shell structure, wherein:
the core is an internal catalyst support; and
the shell comprises a high entropy alloy encapsulating the core;
introducing natural gas into the reactor to form a reaction mixture;
operating the reactor comprising the reaction mixture, thereby forming hydrogen gas and solid carbon, and
separating the hydrogen gas from the solid carbon.

10. The method of claim 11, wherein the operating step further comprises pressurizing the reactor to a pressure between 1 bar and 25 bar.

11. The method of claim 11, wherein the operating step further comprises heating the reactor to a temperature between 300° C. and 1200° C.

12. The method of claim 13, wherein the operating step further comprises heating the reactor using induction heating, plasma heating, microwave plasma or microwave heating, or a solar furnace.

13. The method of claim 11, wherein the high entropy alloy catalyst further comprises a catalyst promoter.

14. The method of claim 15, wherein the catalyst promoter is in the core, in the shell, or both; and wherein the catalyst promoter comprises from 0.0001 at % to 20 at % of the high entropy alloy catalyst.

15. The method of claim 15, wherein the catalyst promoter comprises a metal, an alkali metal, a rare earth metal, a high melting metal oxide, or any combination thereof.

16. The method of claim 11, wherein the core comprises a metal, a metal oxide, or any combination thereof.

17. The method of claim 11, wherein the shell comprises at least four metals, and wherein each of the four or more metals has a composition in the shell from 0.1 at % to 50 at %.

18. The method of claim 11, wherein the at least four metals are selected from the group consisting of cobalt, chromium, iron, manganese, nickel, aluminum, magnesium, copper, zinc, zirconium, ruthenium, rhodium, molybdenum, niobium, palladium, silver, tungsten, rhenium, iridium, platinum, gold, cerium, ytterbium, tin, calcium, and beryllium.

19. The method of claim 11, wherein the shell is designed to increase hydrogen production and decrease carbon dioxide formation by tuning at least one of the following properties: configuration entropy, lattice distortion, diffusion, catalytic activity, adsorption energy, number of catalytically active sites, desorption of reactants, particle size, and surface area.

20. The method of claim 11, wherein the core has an average dimension of from 1 nanometers to 10 micrometers, and wherein the shell has an average thickness of from 1 nm to 10 μm.
